(19) United States
(12) Patent Application Publication
(10) Pub. No.: US 2020/0028289 A1
(43) Pub. Date: Jan. 23, 2020

(54) PCIE/SAS CONNECTOR STRUCTURE

(71) Applicant: AMPHENOL EAST ASIA ELECTRONIC TECHNOLOGY (SHEN ZHEN) CO., LTD., SHEN ZHEN (CN)

(72) Inventors: NIAN DAI, SHEN ZHEN (CN); XIANG WANG, SHEN ZHEN (CN); CHUAN-QI GONG, SHEN ZHEN (CN); LEI LIAO, SHEN ZHEN (CN)

(21) Appl. No.: 16/037,408

(22) Filed: Jul. 17, 2018

(51) Int. Cl. H01R 12/72; H01R 13/405

(52) U.S. Cl. CPC H01R 12/721; H01R 13/405

(57) ABSTRACT

A PCIe/SAS connector structure related to the connector field is provided, including a body member, a terminal assembly, a cover member, and a fixing plate. The body member includes a terminal groove and is formed of a plastic material. The terminal assembly includes a signal terminal and a power terminal, and is inserted in the terminal groove in the body member. The cover member includes an electrically conductive plastic member and a metal cover plate, and structurally formed in a plate shape. When the terminal assembly is inserted in the body member, the cover member is embedded in the body member and disposed at an inner lateral of the terminal assembly. The electrically conductive plastic member is divided into at least two sections. The metal cover plate is embedded in the electrically conductive plastic member. With such configuration, a plurality of advantageous effects are achieved.

### BACKGROUND OF THE INVENTION

### 1. Field of the Invention

The present invention relates to connectors, and more particularly, to a peripheral component interconnect express (PCIe)/serial attached small computer system interface (SAS) connector structure.

### 2. Description of the Related Art

As a six-channel high speed multifunctional connector, a PCIe/SAS is applied as a solution for multiple applications. The system applying such connector supports single-ended SATA, double-ended SATA Express, double-ended SAS, multi-ended SAS, or a PCIe apparatus with four independent ends at most.

As the data storage mass continuously increasing, the transmission rate of connector has to increase as well. Especially for a server storage industry, it means that the clock rate is increasing and the rising duration is rapidly shortened. Therefore, the requirement upon the bandwidth, which represents the transmission rate, is continuously increased.

Also, the terminal of a conventional SAS0 channel is unable to be applied for transmitting a signal under a PCIe protocol, due to the interval difference between the pins of the SAS0 channel and pins of the PCIe channel.

### SUMMARY OF THE INVENTION

For improving the issues above, the present invention discloses a PCIe/SAS connector structure, which fulfills the continuously uprising usage demand.

For achieving the aforementioned objectives, a PCIe/SAS connector structure is provided, comprising a body member, a terminal assembly, a cover member, and a fixing plate.

The body member is formed of plastic material and comprises a terminal groove disposed in the body member.

The terminal assembly comprises a signal terminal and a power terminal. The terminal assembly is inserted in the terminal groove inside the body member.

The cover member comprises an electrically conductive plastic member and a metal cover plate. The cover member is structurally formed in a plate shape.

The terminal assembly is inserted in the body member. The cover member is embedded in the body member and disposed at the inner lateral of the terminal assembly.

The metal cover plate is embedded in the electrically conductive plastic member.

Preferably, the fixing plate is disposed at two ends of the body member, respectively, and the fixing plate comprises fixing bore.

More preferably, the fixing plate is disposed at two ends of the body, such that the fixing bore is able to be welded to be fixed on the PCB.

More preferably, the electrically conductive plastic member is divided into at least two sections, so as to reduce a warp deformation thereof.

More preferably, by adjusting the terminal structure for resolving the interval difference between the pins of the SAS0 signal channel and the pins of the PCIe signal channel, the terminal assembly in the present invention is structurally formed to allow the SAS0 signal channel to be applied for PCIe protocol application.

More preferably, the metal cover plate is connected with the electrically conductive plastic member to form a solid cover structure, so as to solve the crosstalk of the signal channel during a high-speed transmission.

More preferably, the electrically conductive plastic member and the metal cover plate are formed by a two-stage formation, so as to be provided with structural stability.

With such configuration, the present invention achieves following advantageous effects.

Compared with conventional techniques, the PCIe/SAS connector structure is advantageous for fulfilling the market demand in the future. First, the terminal structure allows the SAS0 signal channel to be used for PCIe application. Second, the electrically conductive plastic member is connected with the metal cover plate to form a solid cover structure, so as to solve the crosstalk of the signal channel during a high-speed transmission. Third, the electrically conductive plastic member and the metal cover plate are formed by a two-stage formation, achieving a structural stability. Fourth, the cover plate is structurally divided into different sections, so as to reduce the warp deformation. With the optimized structural, the SAS channel achieves the transmission rate of the PCIe channel (32 Gbps for a single channel). Also, a maximum of six channels (X6) are able to be simultaneously applied for transmission.

### BRIEF DESCRIPTION OF THE DRAWINGS

FIG. 1 is an exploded view of the PCIe/SAS structure.

FIG. 2 illustrates the cover member including an electrically conductive plastic member and a metal cover plate.

### DETAILED DESCRIPTION OF THE INVENTION

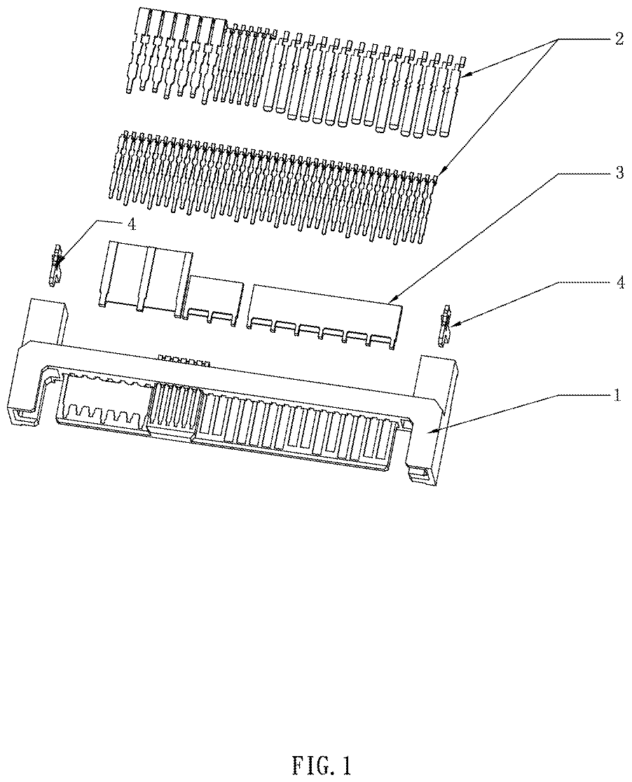

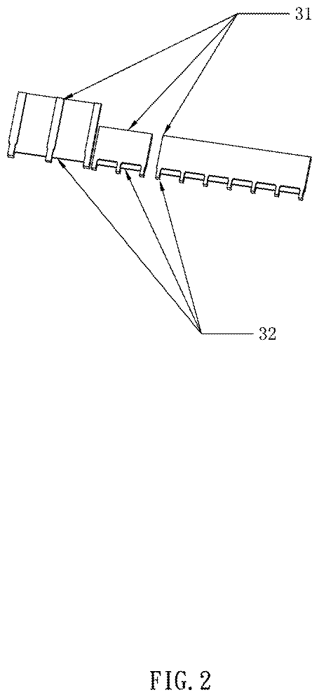

The aforementioned and further advantages and features of the present invention will be understood by reference to the description of the preferred embodiment in conjunction with the accompanying FIG. 1 and FIG. 2 where the components are illustrated based on a proportion for explanation but not subject to the actual component proportion.

### Embodiment 1

Referring to FIG. 1, a novel PCIe/SAS connector structure comprises a body member 1, a terminal assembly 2, a cover member 3, and a fixing plate 4. In particular, the term “PCIe-SAS” describing the connector means that the connector is allowed to be connected with an equipment having a PCIe interface, and also allowed to be connected with an equipment having a SAS interface.

The body member 1 comprises a terminal groove. The body member 1 is formed of a plastic material. The terminal assembly 2 comprises a signal terminal and a power terminal. The terminal assembly 2 is inserted in the terminal groove of the body member 1. When the terminal assembly 2 is inserted in the body member 1, the cover member 3 is able to be embedded in the body member 1 and disposed at an inner lateral of the terminal assembly 2.

Referring to FIG. 2, the cover member 3 comprises an electrically conductive plastic member 31 and a metal cover plate 32. The cover member 3 is structurally formed in a plate shape. The electrically conductive plastic member 31 is divided into at least two sections. The metal cover plate 32 is embedded in the electrically conductive plastic member 31. The fixing plate 4 is disposed at two ends of the body member 1, respectively. The fixing plate 4 includes a fixing bore. The fixing plate 4 is disposed at two ends of the body member 1, such that the fixing bore thereof is able to be welded to be fixed on the PCB. The electrically conductive member 31 is divided into at least two sections to prevent the warp deformation thereof. Also, by adjusting the terminal structure for resolving the interval difference between the pins of the SAS0 signal channel and the pins of the PCIe signal channel, the terminal assembly 2 is structurally formed to allow the SAS0 signal to be applied for PCIe protocol application. The metal cover plate 32 is connected with the electrically conductive plastic member 31 to form a solid cover structure, so as to solve the crosstalk of the signal channel during a high-speed transmission. The electrically conductive plastic member 31 and the metal cover plate 32 are formed by a two-stage formation, achieving a structural stability. With the optimized structural, the SAS channel achieves the transmission rate of the PCIe channel (32 Gbps for a single channel). Also, a maximum of six channels (X6) are able to be simultaneously applied for transmission.

Although particular embodiments of the invention have been described in detail for purposes of illustration, various modifications and enhancements may be made without departing from the spirit and scope of the invention. Accordingly, the invention is not to be limited except as by the appended claims.

1. A peripheral component interconnect express (PCIe)/serial attached small computer system interface (SASS) connector structure comprising
a body member comprising a terminal groove, the body member being formed of a plastic material;
a terminal assembly comprising a signal terminal and a power terminal;
a cover member comprising an electrically conductive plastic member and a metal cover plate, the electrically conductive plastic member being divided into at least two sections, the cover member being structurally formed in a plate shape,
a fixing plate being disposed at two ends of the body member, respectively,
wherein the terminal assembly is inserted in the body member.

2. (canceled)

3. (canceled)

4. The PCIe/SAS connector structure of claim 1, wherein the terminal assembly is structurally formed to allow an SAS0 signal channel to be used for a PCIe protocol application.

5. (canceled)

6. (canceled)
